(19) United States
(12) Patent Application Publication
(10) Pub. No.: US 2014/0372183 A1
(43) Pub. Date: Dec. 18, 2014

(54) TRAILER LOADING ASSESSMENT AND TRAINING

(71) Applicant: MOTOROLA SOLUTIONS, INC, Schaumburg, IL (US)

(72) Inventors: Michael E. Groble, Lake Zurich, IL (US); Karthik Lakshminarayanan, Wilmington, DE (US); Kevin J. O'Connell, Palatine, IL (US); Cuneyt M. Taskiran, Chicago, IL (US); Jay J. Williams, Glenview, IL (US)

(21) Appl. No.: 13/919,069

(22) Filed: Jun. 17, 2013

(51) Int. Cl. G06Q 10/06; G06Q 50/28

(52) U.S. Cl. CPC G06Q 10/0639; G06Q 50/28
USPC 705/7.38

(57) ABSTRACT

A technique for trailer loading assessment includes imaging loading of a trailer using a monitor. A next step includes detecting loading incidents related to package stacking quality during loading of the trailer using image information from the monitor. A next step includes bookmarking detected loading incidents. A next step includes scoring loading incidents. A next step includes displaying, on a graphical user interface, a visual representation of the loading incidents. The monitor can be an infrared three-dimensional depth camera operable to measure distance to a stacked wall of loaded packages, and a video camera operable to provide an optical image to detect loading incidents.

### BACKGROUND

A crucial aspect for Transportation & Logistics customers is the efficient loading of individual packages on trailers at their distribution facilities. It is desired that the loading be done quickly, safely and with as little wasted trailer space as possible. At present, loading procedures typically include guidelines for how to fill the trailer including what order/direction to fill it and how to build stacks of packages that are structurally sound to minimize damage by distributing weight correctly and arranging the packages to not shift or topple during transit.

It is currently difficult to achieve or monitor adherence to these guidelines during operations for multiple reasons. Firstly, there is a problem with loader inexperience. Carrier companies see a large turnover rate for loader positions. The job is hard work with little pay in a demanding environment. It is also a seasonal job requiring many more loaders for few months of the year. Secondly, there is a problem with inadequate training. The demanding environment also leaves little time for training. Most training is “on-the-job” type training with supervisors providing guidance and feedback as possible. Thirdly, there is a problem with speed of loading. Loaders have to work fast; they need to load hundreds of packages per hour or face termination. Safety and quality procedures can be forgotten in the rush. Fourthly, there is a problem with manual loader monitoring. Supervisors are responsible for a number of different doors and need to visit them periodically to check the quality and status of the loading activity. This leaves loaders unmonitored the majority of the time

Procedure violations are therefore commonplace, yet largely undetected and can result in damaged packages, inefficiently packed trailers, and workplace injuries.

Accordingly, there is a need for a technique to more effectively assess adherence to loading procedures and generating training material to reduce loading procedure violations.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified perspective view of a system during loading of a trailer, in accordance with some embodiments of the present invention.

FIG. 2 is a simplified rear view of FIG. 1.

FIG. 3 is another rear view of FIG. 2 showing a loader as they load the trailer, in accordance with another embodiment of the present invention.

FIG. 4 is a simplified flow chart of a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An apparatus and method is described that provides a technique to more effectively assess adherence to loading procedures and generating training material to reduce loading procedure violations. In particular, the present invention can use imaging and depth sensors to capture and analyze loading behavior. The sensor data is analyzed to detect gaps and structural formations of packages. It is also used to detect loader positions and orientations. The system scores the loading behavior and maintains ranking and statistics of wall scores. The score history is used to generate review material such as shift summaries (the best and worst loads or walls) and time-lapsed representations of loads for training purposes.

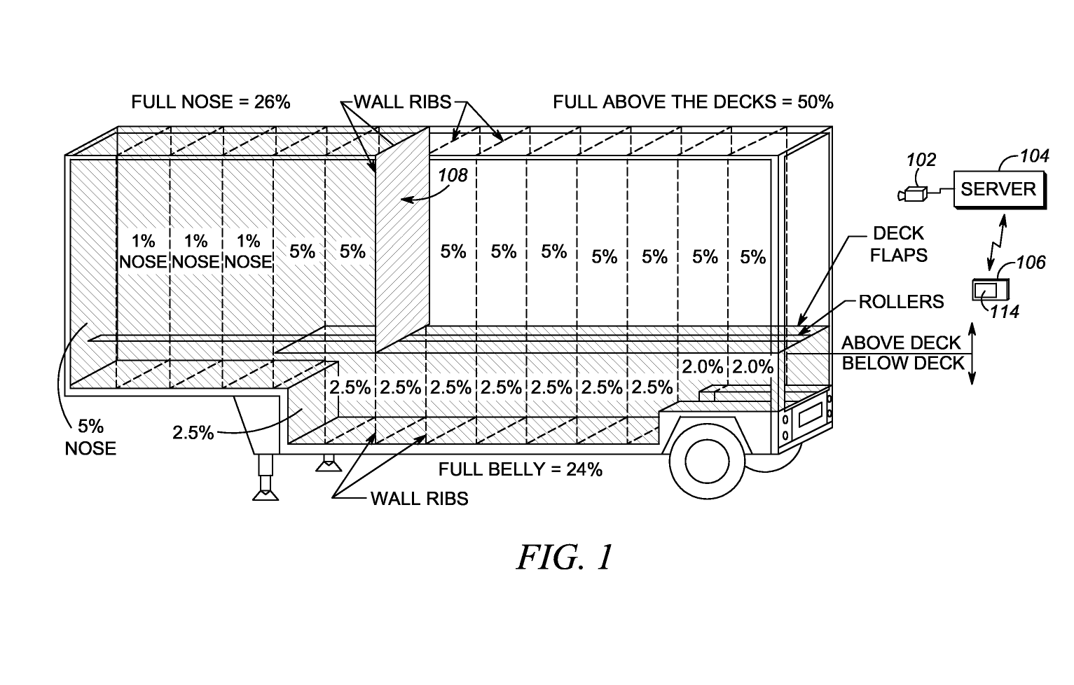

FIG. 1 is a simplified perspective view of a system, in accordance with some embodiments of the present invention. The present invention includes a monitor 102 to image the loading of the trailer. The monitor can comprise a video camera device, such as a RGB camera, as is known in the art, and any type of three dimensional camera, such as a stereo, structured light or time-of-flight depth camera, and the like able to determine a distance to the points (i.e. pixels) in an image. Specifically, the monitor can visualize the building of “walls” 108 of packages stacked in the wall as the trailer is loaded.

The monitor 102 is coupled to a server or processor 104 and is operable to transfer imaging information about trailer loading to the processor. The monitor may transfer the imaging information to the processor using wired (shown) or wireless (not shown) communication, such as a wireless local area network for example. The processor 104 can also provide wireless (shown) or wired (not shown) communication with mobile or fixed-location terminals 106 within the network for purposes of conveying information via a user interface 114 of the terminal or providing instructions to a loader using the terminal about how that person is loading the trailer. The user interface can provide an audible alert or a distinct vibration pattern for a worn device, or the user interface can be a graphical display or textual device. The protocols and messaging needed to establish wireless or wired communications are known in the art and will not be presented here for the sake of brevity.

The processor 104 can monitor trailer loading in real-time using image information from the monitor 102. The processor can process this image information to determine incidents of proper and improper trailer loading and send this information to the graphical user interface 114 of the terminal 106 to display a visual representation of these incidents. The visual representation can be provided on a terminal which can comprise a mobile device, a leaderboard or dashboard, a service kiosk, computer, or a device that is wearable by a loader.

Various entities adapted to support the inventive concepts of the embodiments of the present invention. Those skilled in the art will recognize that the figures do not depict all of the equipment necessary for network to operate but only those components and logical entities particularly relevant to the description of embodiments herein. For example, servers, imaging devices, and communication terminals can all includes separate processors, communication interfaces, transceivers, memories, displays, optical devices, etc. In general, components such as processors, communication devices, displays, and optical devices are well-known. For example, processing units are known to comprise basic components such as, but not limited to, microprocessors, microcontrollers, digital signal processors, memory cache, application-specific integrated circuits, and/or logic circuitry. Such components are typically adapted to implement algorithms and/or protocols that have been expressed using high-level design languages or descriptions, expressed using computer instructions, or expressed using messaging logic flow diagrams.

Thus, given an algorithm, a logic flow, and/or a messaging/signaling flow, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the image processing and control aspects of the present invention may be implemented in any of the devices listed above or distributed across such components. It is within the contemplation of the invention that the operating requirements of the present invention can be implemented in software in conjunction with firmware or hardware.

The present invention maintains a model of the state of the packages. This includes maintaining a package model, which describes a correlation between the unique package ID that is scanned before the package is loaded and the packages' attributes such as length, width and height (or equivalently volume), and weight. During sorting and before loading, each package is passed through a dimensioning scan, which scans the package dimensions and weight, whereupon the system updates the package model.

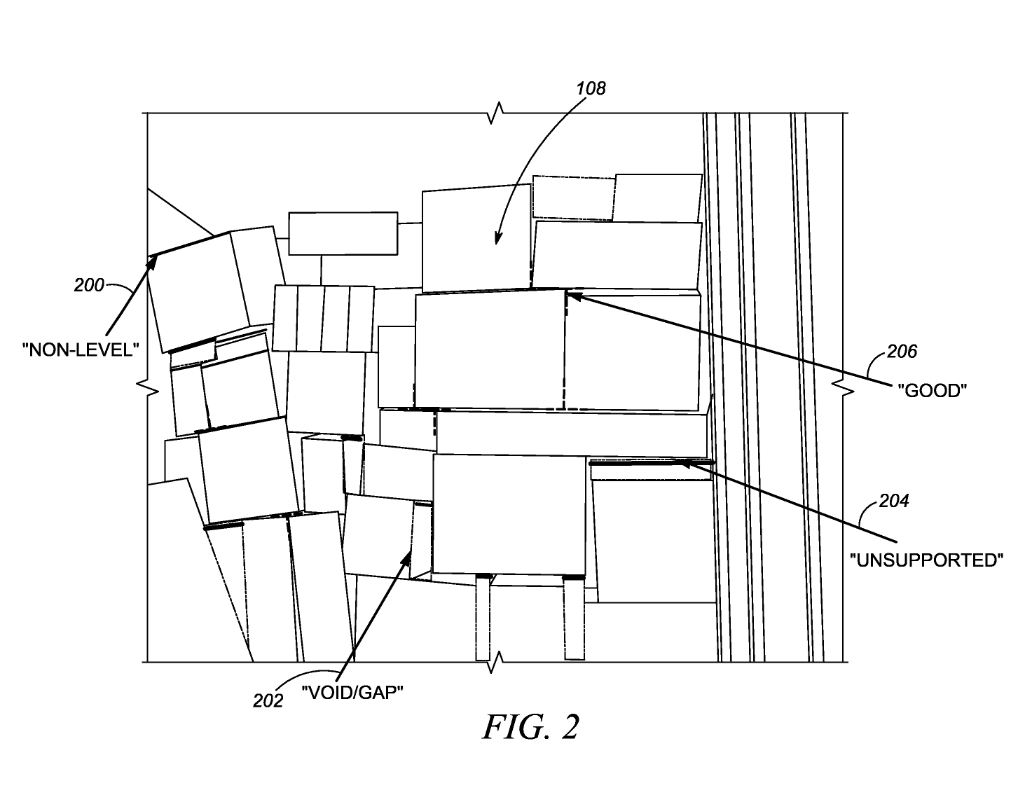

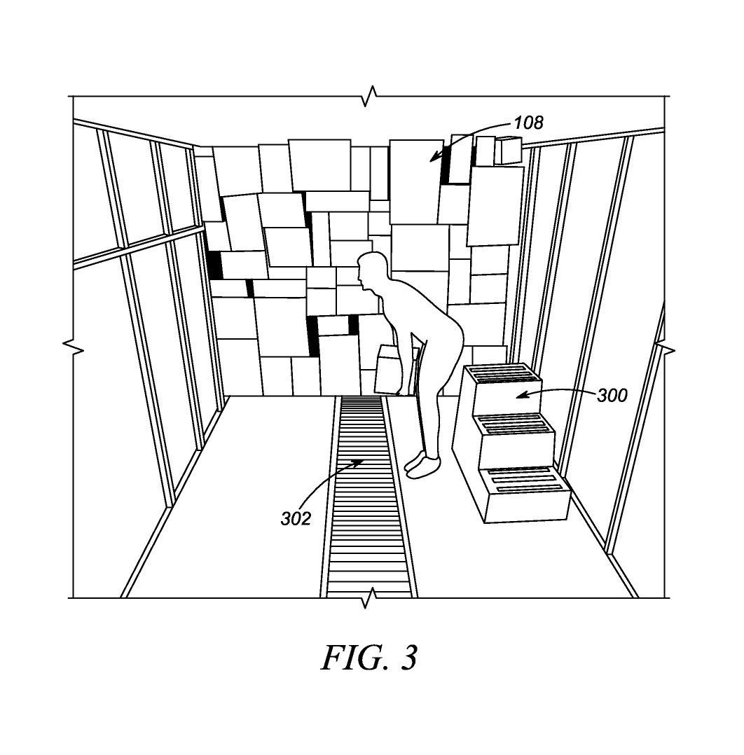

One main aspect of the loading procedure is the correct stacking of packages and the detection of loading procedure incidents. FIG. 2 shows an example of a package wall 108 that has been imaged by the monitor. A number of loading procedure errors is shown. This wall 108 is shown from a rear view in FIG. 1 as seen from the perspective of the monitor. A “T” formation 206 highlights a desirable structural formation, a juncture of boxes where the edges are offset properly, as in a brick wall, and packages are properly supported. This arrow can be annotated “GOOD”. Outlined polygons 202 show gaps, spaces where packages are not tightly packed. This arrow can be annotated “VOID/GAP”. Lines 204 highlight the bottoms of packages that do not have any support, which are structural quality issues. This arrow can be annotated “UNSUPPORTED”. Lines 200 on package tops highlight packages that are not level, again a structural quality issue. This arrow can be annotated “NON-LEVEL”. In contrast, FIG. 3 shows an example of a well structured wall in the sense that it has fewer gaps, overhangs and tilted packages (but note it is not significantly better in terms of “T” formations).

While the present invention makes note of the package loading structure, there can also be improper procedure incidents while the package are being loaded. For example, FIG. 3 shows another significant procedure violation, incorrect posture while lifting boxes. It also shows rollers 302 that run down the center of the trailer and movable stairs. Both of these are potential safety hazards. Safety violations therefore consist generally of incorrect loader poses, including improper lifting posture, standing on rollers 302, and having an incorrect balance on stairs 300. The present invention uses a combination of depth images, infrared images, point clouds and RBG images to not only detect package structural issues but also procedure violations by the loader, cumulatively referred to herein as loading incidents. The processor can detect these loading incidents related to package stacking quality during loading of the trailer using image information from the monitor. As defined herein, a point cloud defines each “pixel” of an image having three-dimensional coordinates. For example, an RGB value from a camera image has an x,y,z location for each pixel. The “point cloud” is that collection of x,y,z location “pixels” detected by the monitor, allowing the recreation of the three-dimensional environment of the trailer.

The processor bookmarks these loading incidents for later review and generation of training material, where the various loading incidents are stored and indexed for future reference. To be useful the loading incidents are also indexed relative to the loading progress. This index material includes: the time that the imaging was taken when detecting the loading incidents, the section of the trailer being loaded (e.g. belly, nose, tail), the properties (dimensions, weight) of the packages in the package wall, the depth of the last completed wall, the fullness of the trailer, the properties (dimensions, weight) for the last scanned package, and the loaders identified via scan information or image processing.

The processor also scores loading incidents. The loading incidents related to package stacking quality include desirable and undesirable structural formations of attacked packages. The natural unit of discussion in trailer loading is a “wall”, i.e. a single depth layer of packages stacked from floor to ceiling. A number of wall quality scores are computed, including: the number of (desirable) “T” formations, the number of gaps, the total gap area, the number of overhangs, the total overhang area, the number of non-level packages, the total non-level area of packages, the number of loader pose violations, and the weight of the package during a loader pose violations (each posture violation is scaled proportional to the weight of the last scanned package). For these incidents, the number of “T” formations, which are good, subtract from the score, and the remaining incidents add to the score. The per-wall scores can then be aggregated to per-trailer or per-trailer-section values, or per loader. An alternate embodiment would compute/aggregate these scores over defined time intervals.

In some cases, such as loader safety, or large gap areas, it may be desirable for a supervisor to be alerted to an excessive score indicating an out-of-limit condition. Out-of-limit conditions are configured for the computed scores and alerts are generated by the processor to a user interface when the score violates a predetermined rule or exceeds a limit. Alerts contain references to scores and images for review purposes, such as the images in FIG. 2 and FIG. 3 which can contain annotations of the actual loading incidents.

From the above steps, the system has collected a repository of depth images, IR images, point clouds, and RBG images, and has generated metadata for these in terms of loading incidents and scores. This information can then be used to generate review and training material for loaders. In particular, the system provides a graphical user interface operable to display a visual representation of the loading incidents for browsing and querying the metadata for review purposes. The metadata also allows root cause analysis, for example identifying which trailer sections have more incidents than others or which set of loaders have more incidents than others. Results may be displayed on a leaderboard for facility-wide review or motivational purposes. It also allows supervisors to generate shift reports highlighting the best and worst examples of the loading activity for feedback and improvement purposes.

Finally, the images taken of the loading can be annotated by the processor with text identifying specific loading incidents, and can be used to generate an interactive time-lapse video of the loading process for desired loading activities. Images can be visually annotated and can also include specific package, wall or loader information from the bookmark metadata. These images and clips can be displayed on the loader's wearable terminal for immediate review, along with links to additional training material.

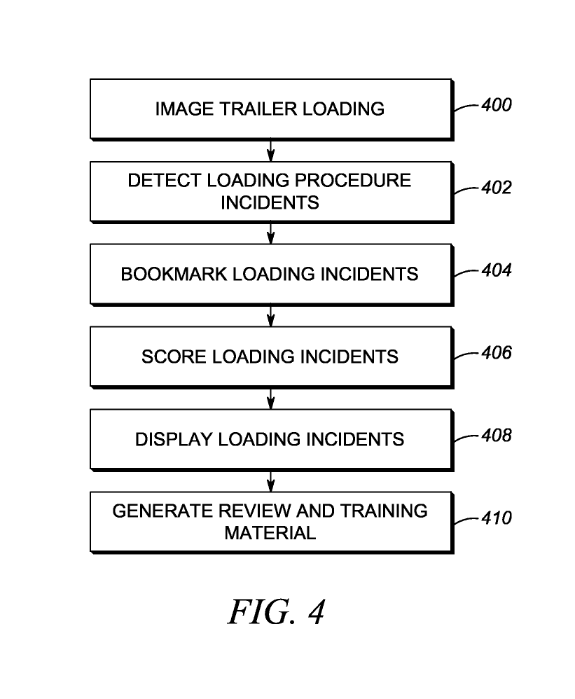

FIG. 4 illustrates a flowchart of a method for trailer loading assessment and training, in accordance with the present invention. The method includes a first step 400 of imaging loading of a trailer using a monitor. The monitor can be a three-dimensional depth/volume camera operable to provide a distance to a wall of stacked packages in the trailer. The monitor also includes a video camera operable to provide an optical image. These images are used to detect 402 loading incidents relating to how packages are stacked and how the behavior of the loader when stacking the packages.

A next step 404 includes bookmarking these loading incidents in terms of loading progress using depth and package scan information.

A next step 406 includes scoring these loading incidents, on a wall-by-wall basis, a roll up to a trailer section, or on a trailer level.

A next step 408 includes conveying or displaying loading incidents, and can include alerting a supervisor if the score violates a rule.

A next step 410 includes generating review and training material based on at least the bookmarking and imaging. This can show good and bad examples, and annotated time-lapse histories.

Advantageously, the present invention detects qualitative measures of a loading process and summarizes the measurements for review and training purposes. The measures include the structural qualities of package walls including gaps, adequate support, and levelness, and also include loader safety including location and lifting pose.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for trailer loading assessment, the system comprising:
a monitor operable to image the loading of a trailer;
a processor coupled to the monitor, the processor operable to;
detect loading incidents during loading of the trailer using image information from the monitor,
bookmarking detected loading incidents, and
scoring loading incidents; and
a user interface operable to convey a representation of the loading incidents.

2. The system of claim 1, wherein the monitor is a video camera operable to provide an optical image during trailer loading and includes a three-dimensional depth/volume camera operable to provide a distance to wall of stacked packages that have been loaded.

3. The system of claim 1, wherein the loading incidents relate to package stacking quality and include desirable and undesirable structural formations of stacked packages.

4. The system of claim 1, wherein the processor is also operable to detect loading incidents related to loader safety during loading of the trailer using image information from the monitor.

5. The system of claim 1, wherein the processor is further operable to generate an alert when a loading incident score violates a rule.

6. The system of claim 1, wherein the processor is further operable to generate review material from imaging and bookmarking information.

7. The system of claim 1, wherein the processor provides a score of loading incidents per wall of stacked packages.

8. The system of claim 7, wherein the processor aggregates scores over defined time intervals.

9. The system of claim 7, wherein the processor aggregates scores per trailer.

10. The system of claim 7, wherein the processor aggregates scores per loader.

11. The system of claim 1, wherein the processor annotates images of loading incidents displayed on the user interface with text identifying specific loading incidents.

12. The system of claim 1, wherein the processor bookmarks loading incidents by indexing the loading incidents relative to loading progress.

13. A system for trailer loading assessment, the system comprising:
a monitor operable to image the loading of a trailer;
a processor coupled to the monitor, the processor operable to;
detect loading incidents related to package stacking quality and loader safety during loading of the trailer using image information from the monitor,
bookmarking detected loading incidents by indexing the loading incidents relative to loading progress, and
scoring loading incidents per wall of stacked packages; and
a graphical user interface operable to display a visual representation of the loading incidents including annotations with text identifying specific loading incidents.

14. A method for trailer loading assessment, the method comprising:
imaging loading of a trailer using a monitor;
detecting loading incidents during loading of the trailer using image information from the monitor;
bookmarking detected loading incidents;
scoring loading incidents; and
conveying, on a user interface, a representation of the loading incidents.

15. The method of claim 14, wherein in the imaging step the monitor is a video camera operable to provide an optical image during trailer loading and includes a three-dimensional depth/volume camera operable to provide a distance to wall of stacked packages that have been loaded.

16. The method of claim 14, wherein detecting also includes detecting loading incidents related to package stacking quality and include desirable and undesirable structural formations of stacked packages.

17. The method of claim 14, wherein detecting also includes detecting loading incidents related to loader safety during loading of the trailer using image information from the monitor.

18. The method of claim 14, wherein the conveying step includes generating an alert when a loading incident score violates a rule.

19. The method of claim 14, further comprising generating review material from the imaging and bookmarking steps.
